(19) United States
(12) Patent Application Publication
(10) Pub. No.: US 2007/0027964 A1
(43) Pub. Date: Feb. 1, 2007

(54) System and method for rapid deployment of network appliances and infrastructure devices

(76) Inventors: Allan Herrod, Mission Viejo, CA (US); Wynn L. Aker, Manorville, NY (US); Robert James Pang, Williston Park, NY (US)

Correspondence Address: FAY KAPLUN & MARCIN, LLP, 15O BROADWAY, SUITE 702, NEW YORK, NY, 10038, US

(21) Appl. No.: 11/191,627

(22) Filed: Jul. 28, 2005

(51) Int. Cl. G06F 15/177

(52) U.S. Cl. 709/220

(57) ABSTRACT

Described is a system having a receiving element to receive configuration information for a network appliance and a generation element to generate codes for a readable element. The readable element is configured to be read by a reading element of the network appliance and the configuration information configures the network appliance for operation on a network.

### BACKGROUND OF THE INVENTION

When network appliances and infrastructure devices such as access points, wireless switches and wired switches are deployed or added to a network, these devices must first be configured with parameters to make the devices operate and suitable for management within the network. As networks become more complex, hierarchical and security characteristics may interfere with traditional automatic configuration methods (e.g., Dynamic Host Configuration Protocol (“DHCP”) to assign Internet Protocol (“IP”) addresses) and discovery methods for new devices (e.g., Simple Network Management Protocol (“SNMP”)). For example, firewalls, network address translation (“NAT”) gateways, selective routers and virtual private networks block traffic between appliances and devices and the services that would typically be necessary to enable automatic configuration and discovery.

Thus, a system administrator needs to manually enter all the necessary configuration information and downloads and installs all the required files. Whether this process is outsourced or executed internally, it is an additional task and cost that delays deployment of the network devices. Therefore, there is a need to expedite the cumbersome roll-out process so that new network devices are ready to connect to the network “out of the box” and perform their required operations with minimal time and effort.

### SUMMARY OF THE INVENTION

Described is a system having a receiving element to receive configuration information for a network appliance and a generation element to generate codes for a readable element. The readable element is configured to be read by a reading element of the network appliance and the configuration information configures the network appliance for operation on a network.

A network appliance including a scanning device to scan a readable element, the readable element including configuration information for the network appliance and an application to process the configuration information and configure the network appliance for operation on a network.

A method for scanning a readable element with a reading element of a network appliance and configuring the network appliance for operation on a network using configuration information stored in the readable element.

### BRIEF DESCRIPTION OF THE DRAWINGS

FIG. 1 shows an exemplary mobile network which may employ an exemplary embodiment of a Rapid Deployment (“RD”) system according to the present invention.

FIG. 2 shows a first exemplary embodiment of a network appliance configured for operation using the RD system according to the present invention.

FIG. 3 shows a second exemplary embodiment of a network appliance configured for operation using the RD system according to the present invention.

FIG. 4 shows a third exemplary embodiment of a network appliance configured for operation using the RD system according to the present invention.

FIG. 5 shows an exemplary embodiment of a set of linear barcodes according to the present invention.

FIG. 6 shows an exemplary embodiment of a two-dimensional barcode according to the present invention.

FIG. 7 shows an exemplary process for operation of the Work Station of the RD system according to the present invention.

FIG. 8 shows an exemplary process for the deployment of the RD software on the network appliance according to the present invention.

FIG. 9 shows an exemplary process for the rapid deployment of a network appliance on the network according to the present invention.

### DETAILED DESCRIPTION

The present invention may be further understood with reference to the following description and the appended drawings, wherein like elements are provided with the same reference numerals. Throughout this description the terms network appliances and infrastructure devices are used interchangeably to describe network distribution devices (i.e., those device which are used as intermediary devices to route packets from the source network device to the destination network device). Examples of network appliances and infrastructure devices include access points, wireless switches, wired switches, routers, management servers, management appliances, etc.

Furthermore, as described above, it is possible that existing network automatic configuration schemes may work when installing a network appliance. This description is directed to exemplary embodiments of the present invention where the currently available configuration schemes do not work to configure the device or where that configuration is not desired. Thus, when a new network appliance is plugged into a network, it is possible that currently available automatic configuration schemes may be attempted prior to using the exemplary embodiments of the present invention.

Before a new network appliance can operate in a network environment, it must undergo an initial configuration to prepare the network appliance to be used on the network. The initial configuration may include an number of steps depending on, for example, the particular task assigned to the network appliance and the type of network on which the network appliance will be included. Configuration steps may include such things as general network configuration, ATM address configuration, Interface configuration, port configuration, IP address configuration, network routing configuration, SNMP management, Ethernet configuration, security configuration, DHCP configuration, Service Set Identification (“SSID”) configuration, wireless configuration, etc.

Those of skill in the art will understand that the above are only a limited number of the types of initial configurations which may have to be carried out in order to prepare the network appliance to be used on the network. Each of these configuration steps will require the system administrator to enter configuration parameters to provide the correct settings and/or values for the network appliance to operate correctly on the network. Examples of configuration parameters may include a security setting such as Wired Equivalent Privacy (“WEP”) in the security configuration, a defined communication channel for a wireless configuration, a network clock setting or general throughput settings for general network settings, a maximum SNMP agent packet size for the SNMP configuration, etc. Again, those of skill in the art will understand that there are any number of possible configuration parameters which may be required and/or optional for the various configuration steps.

Additionally, network owners routinely update their systems with new software, firmware, and programs. Incorrect versions may prevent performance of business functions or produce inaccurate results. By the time a new network appliance is pulled out of its box, the software components originally installed at the factory may already be outdated. Network appliances already connected to the network may need to periodically uninstall software and download and install updates, a process of supplying services known as provisioning. For example, the network may be controlled by an enterprise management system that requires agents to reside on each of the managed devices. The agent may be a software component which needs to be provisioned onto the network appliance and periodically updated as new versions are provided by the vendor of the enterprise management system. Other data that may be delivered to the network appliance may include, for example, static routing tables.

The exemplary embodiments of the present invention described herein include a system and method for rapidly deploying network appliances onto a network. Throughout this description, the exemplary embodiment will be referred to as a rapid deployment (“RD”) system and the various features and functions may be referred to as RD features and functions. The RD system alleviates the need for the time consuming and expensive manual configuration and provisioning of network appliances being added to a network.

The exemplary embodiments provide a readable entity (e.g., barcodes) that are embedded with configuration commands. The scanning of the barcodes allows the network appliances to be quickly and automatically configured to communicate with and receive packets from other network devices. The barcodes themselves may also be encoded with updates, programs and other executables. Network appliances may be configured for the first time or may be reconfigured with new information for operation in the same or a different network.

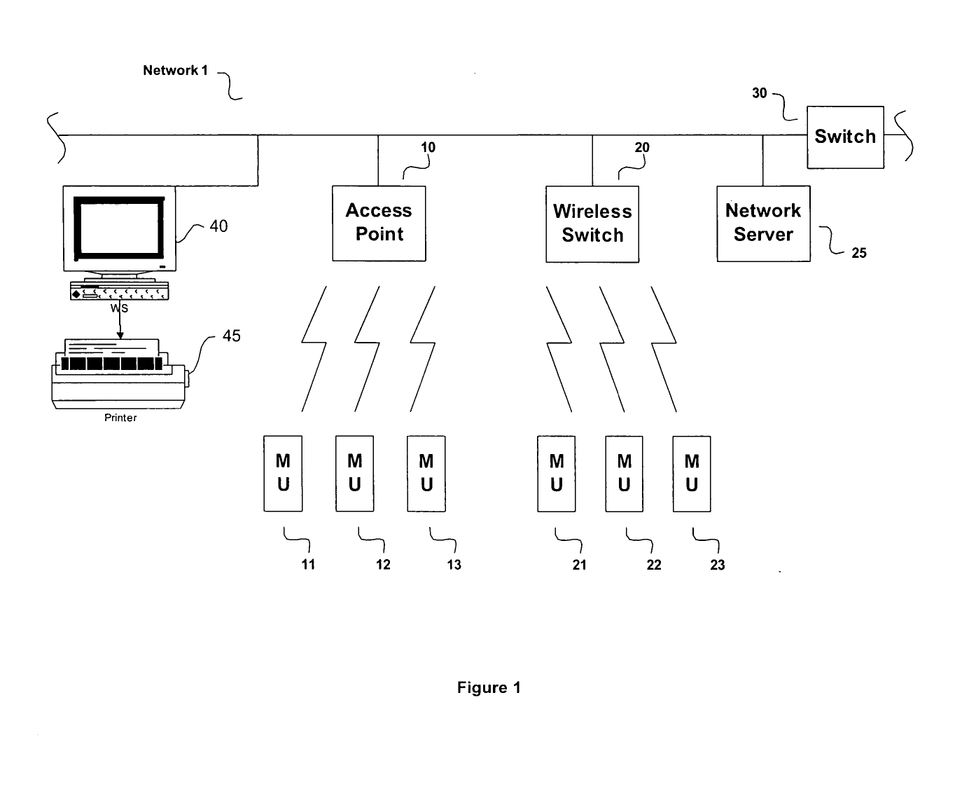

FIG. 1 shows an exemplary network 1 which may employ an exemplary embodiment of the RD system. The network 1 includes an access point (“AP”) 10 that wirelessly communicates with mobile units (“MUs”) 11-13, a wireless switch 20 that wirelessly communicates with MUs 21-23, a network server 25, a network switch 30, a work station (“WS”) 40 and a printer 45. The AP 10, the wireless switch 20 and the network switch 30 may be considered network appliances in network 1. The WS 40 may be, for example, a desktop or a laptop computer. The printer 45 may be connected directly to the WS 40 or may be a network printer.

The foregoing embodiment of a network 1 employing the RD system is not to be construed so as to limit the present invention in any way. As will be apparent to those skilled in the art, the exemplary embodiments of the RD system is not limited any type of network.

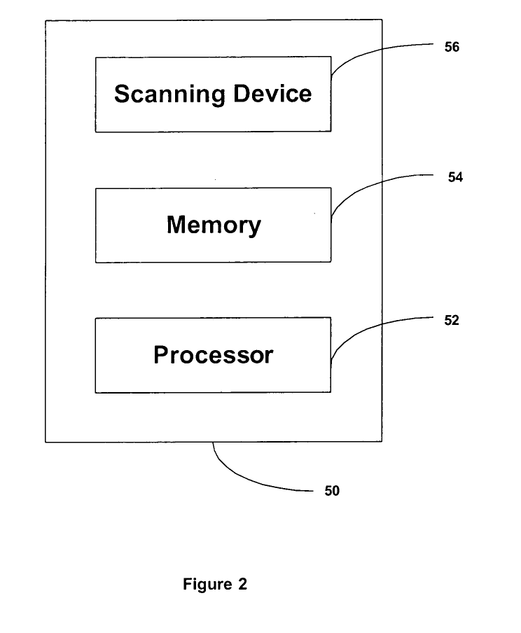

FIG. 2 shows a first exemplary embodiment of a network appliance 50 configured for operation using the RD system. The network appliance 50 includes a processor 52 and memory 54. The exact specifications and type of processor 52 and memory 54 will depend on the type of network appliance. Those of skill in the art will understand that a network appliance may also include any number of other components, such as ports, etc.

As described above, the RD system provides barcodes which may be scanned and used to configure the network appliance when it is added to the network. Typical network appliances are not provided with components allowing the barcodes to be scanned. The network appliance 50 is provided with a scanning device 56 allowing the network appliance 50 to read the barcodes produced by the RD system. The scanning engine may be any type of device allowing for the reading of barcodes or other readable entities, for example, bar code scanner, imager, etc.

Those of skill in the art will understand that while typical network appliances do not have such scanning devices, the miniaturization and cost reduction in scanning engines makes it technically and economically feasible to include scanning devices into network appliances without significantly increasing their size and/or cost. Scan engines have been attached to many devices such as mobile computing devices, but not to network appliances. However, providing a scanning device within the hardware configuration of a network appliance may be accomplished by attaching it through a spare port of the processor 52 and providing software and/or firmware for operating the scanning device 56 that is well known in the art.

From a physical configuration standpoint, the network appliance 50 may have a window in its case through which the scanning device 56 may read any barcodes (or other readable entities) which are placed in front of the window. Those of skill in the art will understand that the case of the network appliance with a window will need to be designed to have the proper physical tolerances (e.g., environmental, breakage, etc.) for the installation location. Thus, a network appliance 50 that is equipped with a scanning device 56 may then read and process the barcodes generated by the RD system of the present invention.

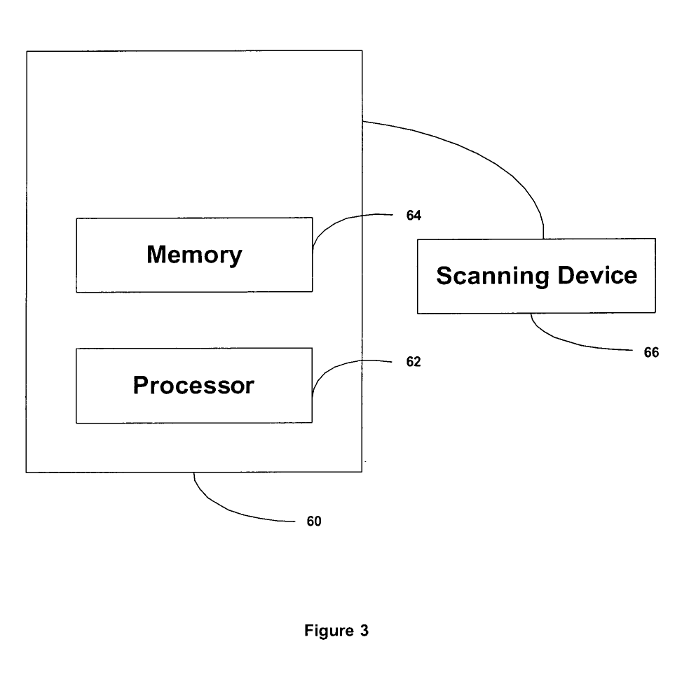

FIG. 3 shows a second exemplary embodiment of a network appliance 60 configured for operation using the RD system. Similar to the above embodiment, the network appliance 60 includes a processor 62 and memory 64. However, in this case, the network appliance does not have an integral scanning device. This may be because the network appliance 60 is a legacy device not equipped with a scanning device or there is some other reason why a scanning device cannot be integral to the network appliance 60.

In this example, the scanning device 66 is not integral to the network appliance 60. The scanning device 66 may be connected via some standard protocol and port (e.g., USB) to the network appliance 60. The scanning device 66 may be connected permanently or temporarily to the network appliance 60. Again, the network appliance 60 may also include software or firmware for operating the scanning device 66. Thus, even in legacy applications, as long as the network appliance has a port or some other manner of accepting a scanning device, the network appliance may use the RD system for configuration because the software (or firmware) for operating the scanning device may be easily downloaded onto the network appliance.

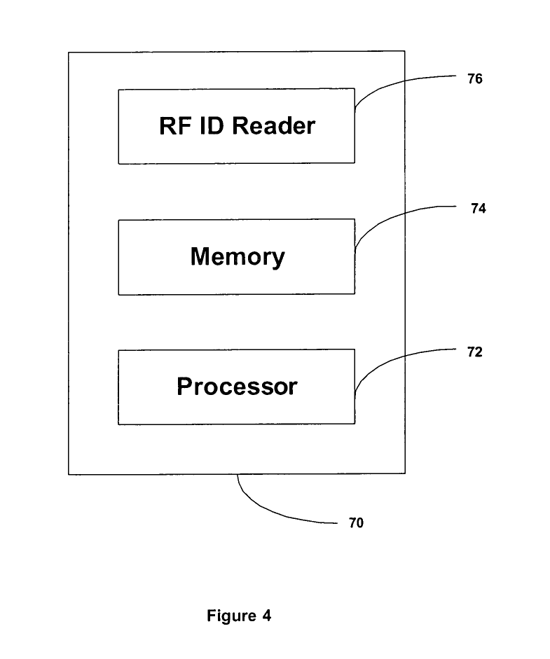

FIG. 4 shows a third exemplary embodiment of a network appliance 70 configured for operation using the RD system. Similar to the above embodiments, the network appliance 70 includes a processor 72 and memory 74. However, in this example, instead of a scanning device, the network appliance 70 includes a radio frequency identification (“RFID”) reader 76. As with scanning devices, RFID readers have never been provided with network appliances. However, the RFID reader 76 may be attached to the network appliance 70 in the same manner as described above for the scanning device, including the downloading of software or firmware for operation of the RFID reader 76.

This example shows that the output of the RD system need not be limited to barcodes or other images, but may also be other types of readable entities such as an RFID tag. The RFID tag may be encoded with the same type of information provided in the barcodes. In this example, an encoded RFID tag may be placed near the RFID reader 76 of the network appliance 70 to read and collect the configuration information for the network appliance 70.

Referring back to FIG. 1, the WS 20 may be running (or have access to) an enterprise management system for the network 1. A portion of the enterprise management system may be a Web-based server-side control software such as that developed by Symbol Technologies, Inc. of Holtsville, N.Y., known as the Mobility Services Platform (“MSP”). The MSP is part of the larger enterprise management system that is used for comprehensive network management. Within the MSP is an RD Tool used to manipulate RD profiles. The RD Tool may include a series of graphical user interfaces (“GUIs”) or other interfaces which allow the system administrator to interact with the RD system. In alternative embodiments, other programs may be running on WS 20 to create, edit, and display RD profiles.

The RD Tool may include a GUI for displaying and editing existing RD profiles and for creating new RD profiles on WS 20. The RD profile may include, for example, network appliance information, configuration steps and various configuration parameters for the network appliance to be configured. Examples of the types of information that may be included in an RD profile include the network appliance model number, the network appliance operating system, the date and time that the profile was created, and the barcode symbology types to be printed. Those of skill in the art will understand that these are only exemplary and that an RD profile may include any information necessary for configuring the network appliance.

The RD system will use the RD profile to generate barcodes for configuration of the network appliances. The barcodes will be described in greater detail below. A system administrator may edit the RD profile or create a new profile by interacting with the appropriate GUI on the WS 40. The RD system will record and save the information that is entered into the RD Tool.

Examples of the types of configuration steps and configuration parameters for a network appliance were provided above. However, the RD system is not limited to either the specific information described or the general types of information described above. Based on specific implementations, other information may be entered into an RD profile.

The RD profile may be set to encode configuration information for a set of network appliances or a particular network appliance identified, for example, by a serial number. The set may be identified by a functional group which may be defined by the system administrator, e.g., all network appliances which belong to a user defined group should have the same configuration information.

The RD profile may generate either an encrypted or an un-encrypted barcode. Encryption may include, for example, system or user-supplied password encryption. For system encryption, the network appliance may include an internal password which allows the network appliance to decrypt the barcode without user interaction. The user password encryption may require an installer of the network appliance to enter a password into the network appliance before decryption of the barcode is performed. The system administrator may set the encryption type and any passwords using the RD Tool.

The generated barcodes may also require server authentication to assure that the barcodes are current. For example, the generated barcodes may include expiration date and/or time or other authentication information, after which the barcodes would no longer be usable. For example, the expiration date/time may be compared against the local date/time on the network appliance being configured or against the date/time of the network server used during server authentication. The use of the network server date/time may be more secure because it prevents users from locally altering the date/time of the network appliance to use the expired barcodes.

When a network appliance scans the barcode, before using the information contained in the barcode for configuring the network appliance, the network appliance may transmit the information to a network server (e.g., network server 25) to verify that the correct barcodes are being used. The system administrator may enable the server authentication and identify the network server which should be used for the authentication through the RD Tool.

The RD Tool may be configured to include various data entry methods such as character entry fields, drop down menus, scroll menus, etc. The menus may include all the selections available to the system administrator for a particular configuration parameter.

If provisioning is desired as part of the network appliance configuration, commands may be encoded into the barcodes to indicate how the network appliance should connect to a provisioning server. Provisioning may be used to download and run packages on the network appliance that contain executable files, applications, software and firmware updates, or any other type of files. Barcodes with large storage capacities can themselves be embedded with commands to perform these services.

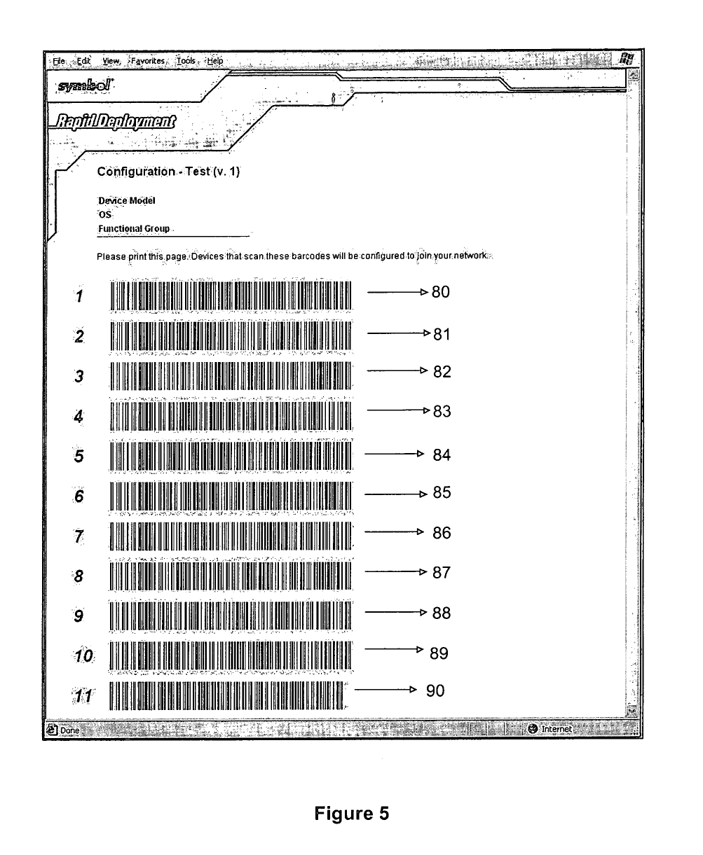

The system administrator may then save the profile and print out the barcodes on the printer 45. The barcodes will include all the information which the system administrator saved for the particular profile. FIG. 5 shows an exemplary embodiment of a set of eleven linear barcodes 80-90 generated from an RD profile. The amount of information that can be stored in a linear barcode 80 is limited by practical considerations such as its printed length and scanner size. Depending on the barcode symbology used, such as Code 39 or Interleaved 2 of 5, the upper limit is normally between 20 to 50 characters. Consequently, encoded RD configuration commands may require a plurality of linear barcodes.

In addition to the configuration commands, each linear barcode 80-90 may be encoded with supplemental information, for example, in a header. The header may include information such as a unique identification for the sheet on which the barcodes are printed, the version number of the barcodes, the barcode encryption and an order of the barcodes. FIG. 4 shows an exemplary screen display having the barcodes 80-90. However, the barcodes may be printed on a sheet of paper for use with the network appliances. In order to control the number of sheets for distribution, each sheet may have a unique identification. This unique identification may be used for authentication purposes. It may also be to ensure that when a user starts scanning one set of barcodes and then attempts to scan a second set of barcodes, the second set of barcodes will not scan, thereby preventing mismatched or spurious information from being input to the network. The version may indicate the particular version of the barcode encoded RD profile. In this example, this is version 1 of the RD profile “test.” The barcode encryption indicates the encryption type of the barcode.

The barcode order indicates the order in which the barcodes 80-90 were encrypted. For example, assuming that the barcodes 80-90 were encrypted in sequential order, the barcode 80 may include information which identifies the barcode 80 as 1 of 11 barcodes, the barcode 81 as 2 of 11 barcodes, etc. This order may allow a user when scanning the bar codes to be assured that each barcode was scanned. For example, a network appliance scanning the barcode may indicate to the user that a barcode is missing, e.g., barcode 3 of 11 was not scanned. Other information may also be included in the header of each of the barcodes.

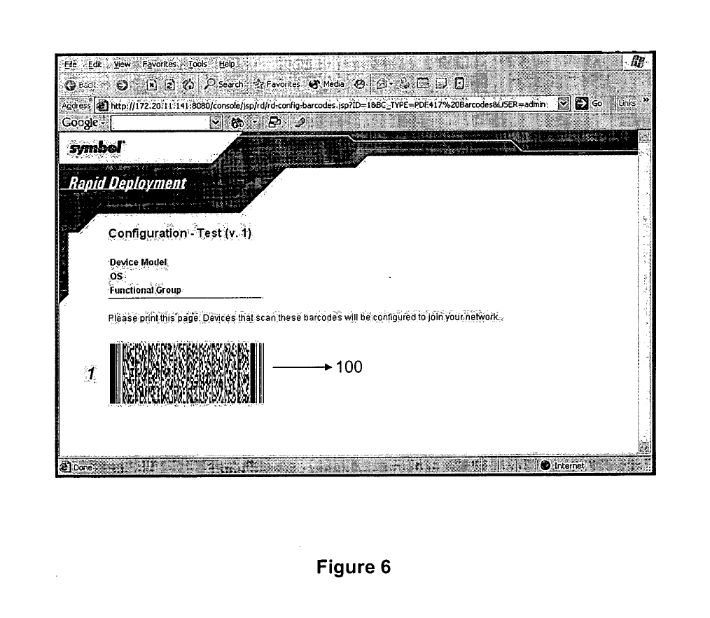

FIG. 6 shows an exemplary embodiment of a two-dimensional barcode. Barcode 100 is of symbology type PDF417. Alternative embodiments may utilize Code 49, Data Matrix, Aztec Code, or any other two-dimensional barcode symbology. Two-dimensional barcodes have a considerably higher storage capacity than their linear counterparts. A PDF417 barcode can store approximately two thousand characters. As a result, all the configuration information contained in an RD profile may be encoded into a single two-dimensional barcode, e.g., barcode 100.

However, in the same manner as described above for the linear barcodes, there may be multiple two-dimensional barcodes used to encode the RD profile. A set of two-dimensional barcodes should contain header information relating to sequence as described above and may also include other header information. This may be the case when the barcode is used to encode lengthy messages, programs, executables, etc.

Furthermore, while the examples of linear and two-dimensional barcodes have been described above, those of skill in the art will understand that other methods of encoding the configuration parameters may also be used. The RD system according to the present invention may be used with any encoding method wherein the network appliance has the ability to read the encoded configuration parameters and configure itself for operation on the network.

As described above, the configuration information may be encoded on an RFID tag and read by an RFID reader of the network appliance. Thus, in this case, the RD system would include a device for encoding an RFID tag rather than a printer to print barcodes, e.g., printer 45 of network 1 may be replaced with a RFID tag encoder.

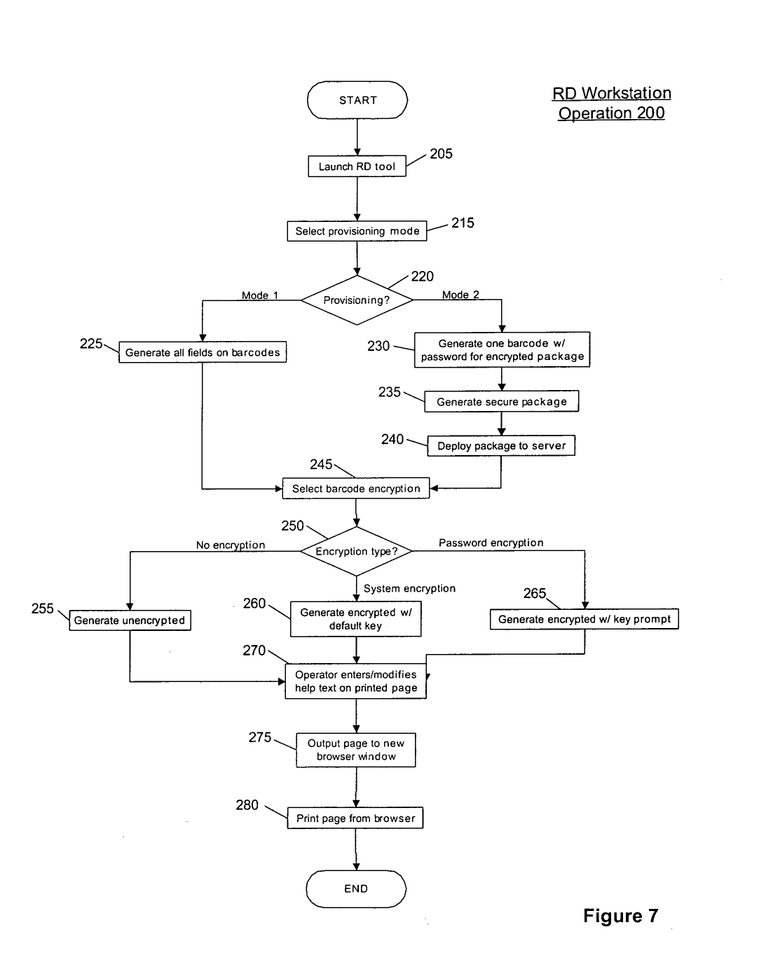

FIG. 7 shows an exemplary process 200 for the WS 40 operation of the RD system. This process 200 may either be outsourced to a third party or executed internally by the owner of the wireless network. For example, the third party may be the vendor of the device such that the barcodes may be included in the box with the device. Throughout this description, it will be considered that the system administrator will be operating the WS 40. Initially, the RD Tool is launched on the WS 40 in step 205. In step 215, the system administrator selects the provisioning mode for the RD system. In step 220, the RD Tool determines the selected provisioning mode. In mode 1, all the provisioning information is stored in the generated barcode. Thus, in step 225, the system administrator enters all the provisioning information into the RD profile and this information will be encoded into the barcode when it is generated. All the provisioning information is self-contained in the barcodes.

However, if the system administrator selects mode 2 provisioning, the barcode will contain information as to where the network appliance may obtain the desired provisioning packages. A special barcode is generated in step 230 containing password information for accessing provisioning packages from a network server. The barcode may also contain additional information such as the name of the host server, the path for the package, the transfer protocol, etc.

In a next step 235 of provisioning mode 2, the provisioning package is created and secured by a password. As described above, a provisioning package may include a series of applications and services that is to be deployed on the network appliance. This package of applications and services may be stored on a network server (e.g., network server 25). The RD tool may be used to create this package on the network server. In step 240, the provisioning package is deployed to the provisioning network server.

Those of skill in the art will understand that a system administrator may not need to generate the provisioning package each time a profile is created. For example, a new RD profile may use a previously created provisioning package. Thus, the information for the previously created provisioning package may be stored in the new RD profile, making steps 235 and 240 optional.

In step 245, the system administrator selects the type of barcode encryption to be used. The RD tool determines the selection in step 250 and the RD Tool performs one of three encryption tasks. The first task as shown in step 255 is to generate barcodes without any encryption. The second task as shown in step 260 is to generate barcodes with system encryption, i.e., encrypted with an individual network appliance internal password. The third task as shown in step 265 is to generate barcodes which are encrypted with a password, i.e., the installer of the network appliance must enter a password before the barcodes are decrypted.

As a final step before the barcode sheet is ready to be output, the system administrator may create or modify instructions to be printed along with the barcodes in step 270. An output page is then displayed with the generated barcode sheet(s) in a browser on the WS 40 in step 275. Finally, in step 280, the barcode sheet(s) are printed from the printer 45. At the completion of the process 200, the system administrator has generated barcode sheet(s) for use in the configuration of a network appliance.

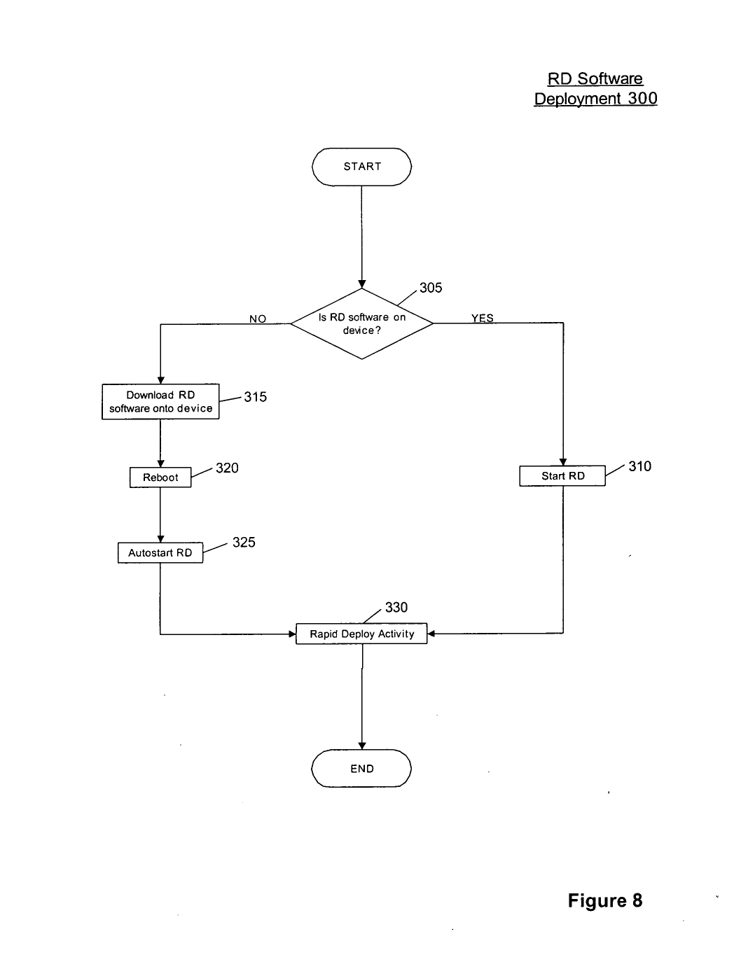

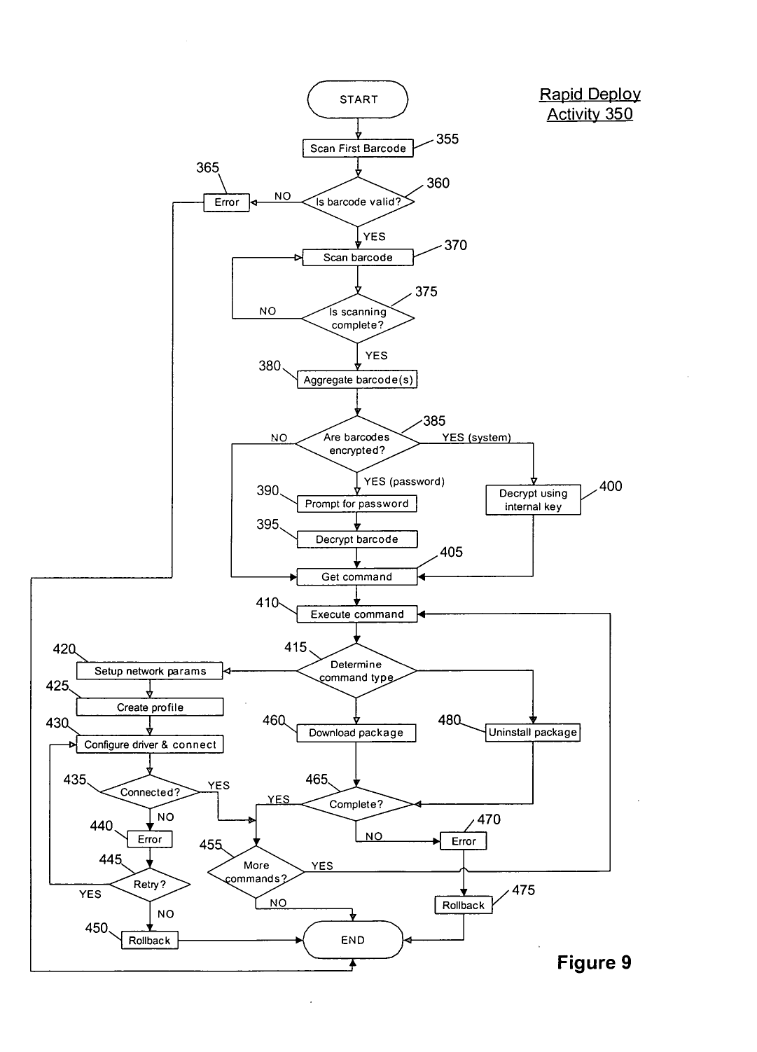

FIGS. 8 and 9 show exemplary processes relating to the network appliance side RD system roll-out. Whether being taken out of the box for the first time or being reconfigured for a different network, each network appliance must initially be running the necessary RD system software. In the description of FIGS. 8 and 9, it is assumed that the network appliance side RD software is installed on the network appliance and the various displays provided to the installer are from the network appliance. However, it is also possible, that there is either a computing device that is temporarily connected to the network appliance or a computing device currently on the network which provides the functionality for the network appliance.

FIG. 8 shows an exemplary process 300 for the deployment of the RD software on the network appliance. In step 305, the installer of a network appliance that is to be added to a network determines whether the device already contains the RD software. If the RD software is already loaded onto the network appliance, the installer simply needs to start the RD program in step 310 and then begin the desired activity in step 330.

However, if the RD software is not already loaded, the user will download the RD software to the network appliance in step 315. A network which uses the exemplary RD system, may have the RD software distributed at various locations throughout the network to allow for easy access by installers of the network appliances. After the RD software is downloaded to the network appliance, it is rebooted in step 320, and the RD software may automatically start upon reboot in step 325. The user may then commence the rapid deploy activity in step 330.

FIG. 9 shows an exemplary process 350 for the rapid deployment of a network appliance on the network. The process 350 is an expansion of the RD activity step 330 in FIG. 8. An installer of a network appliance obtains a barcode sheet (or other readable entity) from the system administrator. The network appliance may be a new network appliance or a previously connected network appliance that needs to be re-configured for any one of a variety of reasons.

In step 355, a first barcode on the barcode sheet is scanned. In step 360, it is determined whether the scanned barcode is valid. Invalid barcodes may be the result of the user receiving a barcode sheet that does not match the network appliance that the user is attempting to configure. For example, the barcodes may have an expiration date and the date may have passed resulting in invalid barcodes. The RD software may check the expiration date or it may contact a network server to determine whether the sheet(s) remain valid. In a further example of invalid barcodes, the barcodes that are scanned may not even be RD barcodes. Those of skill in the art will understand that there may be many other reasons for invalid barcodes. If the barcodes are invalid, the process continues to step 365 where an error is generated on the network appliance for the installer and the process ends.

If the barcodes are valid, the network appliance continues to scan the remaining barcodes in step 370. The process continues to loop through steps 370 and 375 until all the barcodes have been scanned. As described above, the barcodes may include header information indicating the number of barcodes that make up the complete set. Thus, the installer may receives prompts and continue scanning until the set is complete. Once all the barcodes are scanned, they are aggregated sequentially in step 380.

In step 385, the RD software on the network appliance determines the encryption type of the barcodes. If the barcodes are not encrypted, the process continues to step 405 which will be described below. If the barcodes are encrypted, they may be encrypted with a system password or a user password. If the encryption includes a user password, a prompt for the password is displayed on the network appliance (step 390). The installer enters the correct password and the barcodes are decrypted in step 395. If the password is incorrect, the installer may be prompted for the password again. There may be a limit to the number of attempts at entering the correct password. Upon exceeding this limit, the installer may be locked out of the network 1 and/or the network appliance until the system administrator intervenes. The steps related to incorrect passwords are not shown in the exemplary process 350.

The third type of encryption is system encryption. In this encryption, the network appliance will include an internal password which may be used to decrypt the barcodes as shown in step 400. If the network appliance does not have the correct internal password, the barcodes will not be decrypted and intervention from the system administrator may be required.

In step 405, the commands which are resident in the scanned barcodes are extracted. In step 410, the network appliance begins executing the commands contained in the barcodes. In this example, there are three general types of commands and each of these will be described. The first type of command is a network setup command. If the command is to add the network appliance to the network for the first time, the first command may be for setting up network parameters, represented by step 420. As described above, the RD profile will include the network configuration parameters for the network appliance. When the command is executed these configuration parameters will be set and stored as the local profile for the network appliance in step 425.

In step 430, the RD software configures the various network drivers on the network appliance and attempts to connect to the network 1 to determine if the configuration was successful. In step 435, the RD software determines if the network appliance is connected to the wireless network 1. If the network appliance has not connected to the network 1 after a time out period, an error message is generated on the network appliance in step 440 and the installer is prompted to retry the connection in step 445. If the installer selects a retry, the process loops back to step 430 where the network appliance again attempts to connect to the network 1.

If the installer aborts the connection in step 445, the process continues to step 450 where the network appliance is rolled back to its previous settings. Roll back refers to the network appliance being reset to the settings it contained prior to the execution of the RD command. While not shown in the process 350, the network appliance may store any configuration settings which are changed by the RD command in a buffer until the entire RD transaction has been successfully completed. The success may be determined by user prompt or by a successful operation by the network appliance. For example, if the network appliance had successfully connected to the network 1 in the above example, and that was the last command to be executed in the RD transaction, the buffer storing the previous settings may have been cleared upon the successful connection or after the user received a prompt indicating the successful connection. However, when the command is not successful, the network appliance may be rolled back to its previous settings as if the RD command had not been executed.

Other situations in which the network appliance may need to roll back to a previous state include where an RD command is interrupted or not completed because of errors during execution. For example, the user may accidentally power off the network appliance while the RD commands are still being executed or the network appliance may crash due to software and/or hardware conflicts. The system administrator may also have entered incorrect configuration or provisioning information when creating the RD profile, causing attempts to connect to time out. If roll back is indeed necessary, the network appliance may reboot, retrieve and restore the prior settings. Once the system is rolled back to the saved state, the new configuration commands may then be re-run until execution is complete.

The RD system may include commands relating to the start of a transaction and the end of a transaction to mark the beginning and end of the RD transaction. The start transaction marker may indicate that the system should save all the current settings into a buffer because an RD transaction is about to be commenced. The end transaction marker may indicate that the current transaction has been completed successfully and therefore the buffers may be cleared.

Referring back to the process 350, if the network appliance successfully connects to the network 1, the process 350 continues to step 455 to determine whether there are additional RD commands to be executed. If there are the process continues back to step 410 to execute the next command. Otherwise, the process 350 is complete.

The second general type of command is related to the downloading of provisioning packages. In step 460 the network appliance downloads the provisioning package. As described above, the complete provisioning commands may be included in the barcodes or the server information for obtaining the provisioning packages may be included in the barcodes. In either case, the network appliance will use the encoded information to download the provisioning package. In step 465, the network appliance determines if the download was successful. If successful, the process 350 continues to step 455 to determine whether there are additional RD commands to be executed and back to step 410 to execute the next command or the process is complete. If the download is unsuccessful, the process continues to step 470 where the installer receives an error message and the network appliance is rolled back to the original settings in step 475.

The third general type of command is related to the un-installing of provisioning packages which are no longer needed on the network appliance. In step 480 the network appliance un-installs the provisioning package as indicated in the RD command. The process then continues to step 465 and continues in the manner described above.

At the successful completion of the process 350, the network appliance has been configured for connection to the wireless network and has been provisioned with the software applications and services needed for its operation. This configuration was accomplished by downloading or including the RD software on the network appliance (or related device) and scanning the bar codes. Thus, the RD system allows for the rapid deployment of a network appliance with little or no interaction by the installer of the network appliance. Using the RD system, a system administrator may be able to create a single profile for a certain type of device or grouping of devices and deploy hundreds of these devices by merely having the installers scan barcodes which include the profile. This alleviates the need for the system administrator or the installer from having to individually set up each of the devices.

The above described examples included network settings and provisioning information. However, other types of information may also be included in the generated barcodes. For example, the barcodes may include licensing information for the device and/or software included on the device. This licensing information may include manners of registering the device when it is connected to the network, accepting use licenses for software, etc. Thus, the barcode configuration is not merely limited to network settings and provisioning information, but may be extended to any parameters that need to be set based on the devices use on the network to which it is connected.

In addition, as described above, the information that is encoded in the barcodes does not need to be limited to parameters and parameter values. It may be possible to encode executable files in the barcodes. These executables may be software programs or portions of software programs such as procedures or functions. Other types of information also include parameters which trigger the execution of code at remote locations, e.g., the download of software from a network server.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a receiving element to receive configuration information for a network appliance; and
a generation element to generate codes for a readable element, the readable element configured to be read by a reading element of the network appliance, wherein the configuration information configures the network appliance for operation on a network.

2. The system of claim 1, wherein the readable element is one of a linear bar code, a two-dimensional bar code and an RFID tag.

3. The system according to claim 1, wherein the receiving element includes a graphical user input for a user to enter the configuration information.

4. The system of claim 1, wherein the configuration information includes one of device information, network settings, wireless settings, provisioning information and licensing information.

5. The system of claim 1, wherein the readable element includes executable codes.

6. The system according to claim 1, wherein the readable element is encrypted.

7. The system according to claim 6, wherein the encryption is one of a system password encryption and a user-supplied password encryption.

8. The system of claim 1, wherein the readable element includes a plurality of readable elements and each of the plurality of readable elements includes information which uniquely identifies each of the plurality of readable elements.

9. A network appliance, comprising:
a scanning device to scan a readable element, the readable element including configuration information for the network appliance; and
an application to process the configuration information and configure the network appliance for operation on a network.

10. The network appliance of claim 9, wherein the readable element is one of a linear bar code, a two-dimensional bar code and an RFID tag.

11. The network appliance of claim 9, wherein the application transmits the configuration information to a network server to verify the configuration information is correct.

12. The network appliance of claim 9, wherein the configuration of the network appliance includes connecting to a provisioning server and downloading one of a further application and a configuration to the network appliance.

13. The network appliance of claim 9, wherein the scanning device includes one of a barcode reader, a camera, an optical character recognition element and an RFID reader.

14. The network appliance of claim 9, wherein the network appliance is one of an access point, a wired switch, a wireless switch, a management appliance, a management server and a router.

15. A method, comprising the steps of:
scanning a readable element with a reading element of a network appliance; and
configuring the network appliance for operation on a network using configuration information stored in the readable element.

16. The method of claim 15, further comprising the step of:
verifying the readable element is valid before configuring the network appliance.

17. The method of claim 15, wherein the readable element is a plurality of readable elements, the method further comprising the step of:
aggregating the configuration information from the plurality of readable elements.

18. The method of claim 15, further comprising the step of:
decrypting the readable element.

19. The method of claim 15, further comprising the step of:
rolling back the network appliance to previous configuration settings when the configuration using the configuration information in the readable element is unsuccessful

20. The method of claim 15, wherein the reading element of the network appliance includes one of a barcode reader, a camera, an optical character recognition element and an RFID reader.

21. The method of claim 15, wherein the network appliance is one of an access point, a wired switch, a wireless switch, a management appliance, a management server and a router.
